(19) United States
(12) Patent Application Publication
(10) Pub. No.: US 2004/0161367 A1
(43) Pub. Date: Aug. 19, 2004

(54) Apparatus and method for detecting chlorine dioxide

(76) Inventors: Bryan I. Truex, Belleair Beach, FL (US); Stephen A. Straughan, Houston, TX (US)

Correspondence Address: FULBRIGHT & JAWORSKI, LLP, 1301 MCKINNEY, SUITE 5100, HOUSTON, TX, 77010-3095, US

(21) Appl. No.: 10/366,198

(22) Filed: Feb. 13, 2003

(51) Int. Cl. G01N 21/00

(52) U.S. Cl. 422/59; 422/83

(57) ABSTRACT

An apparatus for detecting chlorine dioxide in a vapor having both chlorine dioxide and molecular chlorine includes a filter tube operable to remove molecular chlorine from the vapor and a detection tube connected to the filter tube to detect chlorine dioxide in the vapor after the molecular chlorine has been removed. An air pump is provided to create pressure sufficient to force or draw the vapor through the filter and detection tubes. The filter tube includes a material, such as sulfamic acid, that chemically reacts with the vapor to remove the molecular chlorine from the vapor.

### TECHNICAL FIELD

The present invention relates generally to an apparatus and method for detecting the presence of a target substance in a gaseous environment. More particularly, the present invention relates to such an apparatus and method for detecting the presence of chlorine dioxide in a gaseous environment containing both chlorine dioxide and molecular chlorine.

### BACKGROUND OF THE INVENTION

Chlorine dioxide is used in a wide variety of commercial processes. For example, it is used in processes for disinfecting drinking water, treating industrial water, cleaning pipelines and chemical tanks, and scrubbing nitrogen or sulfur dioxides. Chlorine dioxide is also used as a bleaching agent, and to control microbes and odor in the food and beverage industry.

In many of these commercial processes, it is desirable to monitor the concentration of chlorine dioxide present. For example, sodium chlorite often provides the precursor for chlorine dioxide generation. The efficiency of the conversion of sodium chlorite to chlorine dioxide may be evaluated by quantifying the chlorine dioxide concentration that results. In other applications, the chlorine dioxide levels may have to be maintained within a specific range of concentrations in order to achieve maximum results.

The chlorine dioxide in many of these processes coexists in solution with a quantity of molecular chlorine. To quantify the concentration of chlorine dioxide in a solution comprising both chlorine dioxide and chlorine in its molecular state (hereinafter “molecular chlorine” or “chlorine”), one is normally limited to the use of various titration methods, calorimetric methods, or spectroscopic methods. Where the chlorine dioxide coexists with molecular chlorine in vapor, the chlorine dioxide may be quantified by applying a “conversion factor” to a molecular chlorine measurement that is obtained using an electrochemical cell detector. Alternatively, the concentration of chlorine and chlorine dioxide can be simultaneously measured using light absorption coupled with digital processing.

### BRIEF SUMMARY OF THE INVENTION

It is one of multiple objects of the present invention to provide an apparatus for detecting chlorine dioxide in a vapor having both chlorine dioxide and molecular chlorine. In one aspect of the invention, an apparatus is provided having a first container and a second container. The first container holds or includes a first material adapted to remove molecular chlorine from a vapor having both chlorine dioxide and molecular chlorine. The second container holds or includes a second material adapted to detect chlorine dioxide. The first and second containers are fluidly interconnectable (e.g., directly or via fluid connector element) such that a vapor can be passed through the first container to remove or filter molecular chlorine therefrom and then into the second material to detect chlorine dioxide. Moreover, the first and second containers are preferably connectable to provide a field-carryable unit having both a molecular chlorine filter element and a chlorine dioxide detector element.

The first material is preferably a material, such as sulfamic acid, that is chemically-reactive with the molecular chlorine. The second material is preferably a material, such as o-tolidine or 3,3,5,5 tetramethylbenzene, that is colorimetrically-reactive with chlorine dioxide to produce a color change in the second material, whereby the intensity of color change is proportional to the concentration of chlorine dioxide detected. In the preferred apparatus, the second container is a transparent container with a readable scale. The scale is disposed on the transparent container so as to provide a ready measure of the intensity of second materials color change (e.g., the length of the color stain) and calibrated to provide or read the chlorine dioxide concentration that corresponds to the intensity of the color change. Thus, by using the scale to read the intensity of the color change, the user obtains the concentration of chlorine dioxide in the vapor.

A method of detecting a concentration of chlorine dioxide in a vapor having both chlorine dioxide and molecular chlorine, according to the invention, includes the initial steps of providing a chlorine filter element and a chlorine dioxide detector element, both preferably in tubular containers, and fluidly interconnecting the two elements. The vapor is then passed past the filter element, thereby separating molecular chlorine and chlorine dioxides in the vapor. The separated chlorine dioxides are then directed past the chlorine dioxide detector element, thereby causing the chlorine dioxide detector to detect the concentration of chlorine dioxide passed. In a preferred embodiment, the chlorine filter element includes a material reactive with chlorine such as sulfamic acid. Thus, the vapor passing past the filter element causes the sulfamic acid to react with the vapor, thereby removing the molecular chlorine from the vapor.

In an alternative embodiment, the apparatus includes a tubular body having an inlet, a filter section, a chlorine detection section, and an outlet. Positioned in the filter section is a material (e.g., sulfamic acid) that chemically reacts with vapor having both chlorine dioxide and molecular chlorine to remove or filter molecular chlorine from the vapor. A second material is positioned in the chlorine detection section. This second material colorimetrically reacts with chlorine dioxide to produce a color change of an intensity proportional to the concentration of chlorine dioxide to which the second material is exposed. Thus, the vapor enters the inlet and passes by the first material, so that the molecular chlorine is removed from the vapor. Then, the vapor passes by the second material, whereby the concentration of chlorine dioxide is detected upon the observable change in color of the second material.

### BRIEF DESCRIPTION OF THE DRAWINGS

FIG. 1 is a simplified diagram depicting an apparatus for detecting chlorine dioxide according to the present invention;

FIG. 2 is a simplified diagram depicting the filtration and detection tubes according to the present invention; and;

FIG. 3 is a simplified diagram depicting an alternative apparatus for detecting chlorine dioxide according to the present invention.

### DETAILED DESCRIPTION OF THE INVENTION

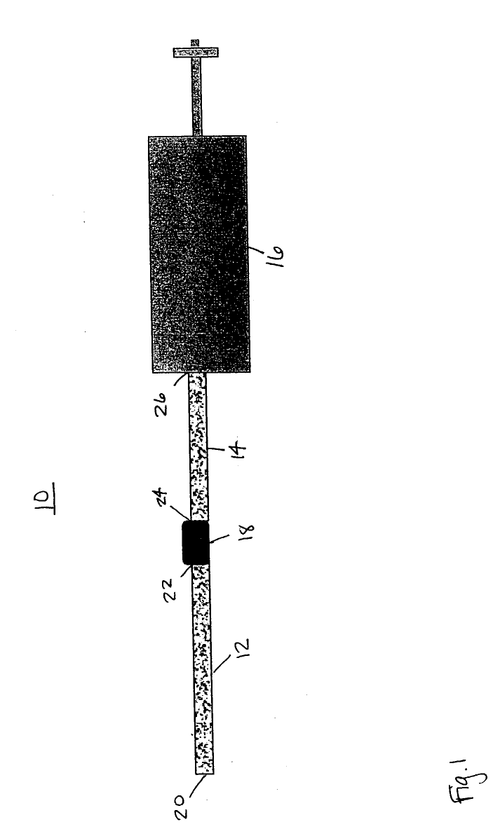

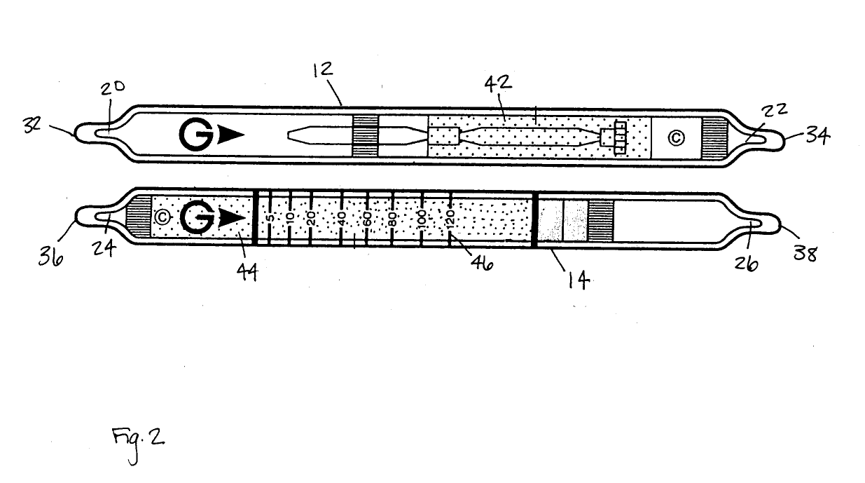

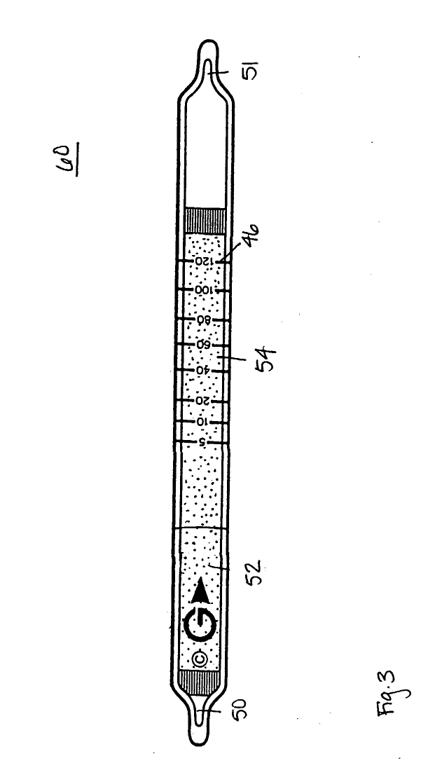

FIGS. 1 and 2 depict an apparatus for detecting chlorine dioxide embodying various aspects of the present invention. FIG. 3 provides a second apparatus, also embodying various aspects of the invention, but according to an alternative embodiment. The inventive apparatus is operable to detect the concentration of chlorine dioxide in a vapor containing both chlorine dioxide and molecular chlorine. In one aspect of the invention, the apparatus is operable to detect the chlorine dioxide in the vapor independently from the molecular chlorine or, from another perspective, to detect the chlorine dioxide directly. With either apparatus depicted, this is accomplished by first separating the molecular chlorine from the chlorine dioxide and then detecting the chlorine dioxide.

As used herein, the term “detected” or “detection” is used to refer to a primary function or result of the inventive method. More specifically, the inventive apparatus is used to “detect” the presence of or a concentration of chlorine dioxide. However, detection of the chlorine dioxide preferably includes providing a measure of the amount or concentration detected and readily communicating this measurement to the user (e.g., by a color change or other observable indication).

Furthermore, the terms “remove” and “filter” are used to refer to the process that separates the molecular chlorine and chlorine dioxide prior to the detection of the chlorine dioxide. These terms are understood to mean simply that, with respect to the vapor that contains both the chlorine and the chlorine dioxide, the molecular chlorine is segregated from one or more elements of the vapor (i.e. chlorine dioxides). In the preferred process, the molecular chlorine is separated from the vapor while the rest of the vapor, including the chlorine dioxide, continues to flow to the detection section of the apparatus.

It should first be noted that, upon review of the detailed description and the drawings provided herein, it will become apparent to one of ordinary skill in the relevant art (e.g., the instrumentation or measurement art) that various aspects of the present invention may also be applicable to other means for detecting chlorine dioxide in a local gaseous environment. For example, it will become apparent that certain features of the apparatus described in FIGS. 1-3 may be modified or incorporated with other measurement systems, so as to provide for the detection of chlorine dioxide independent of the presence of other elements in the vapor in which the chlorine dioxide is contained. More specifically, the concept of providing within one apparatus a section or element for separating the molecular chlorine prior to detection of the chlorine dioxide may be incorporated into known measuring/detection systems. Thus, the present invention is not intended to be limited to the structures and methods specifically described and illustrated below.

Referring to FIGS. 1 and 2, there is shown an illustrative embodiment of the apparatus and method of the present invention for detecting chlorine dioxide in a vapor having both chlorine dioxide and molecular chlorine. FIG. 1 depicts the apparatus as a field-carryable unit assembled and ready for operation. FIG. 2 depicts the apparatus prior to operation and prior to assembly of its major elements.

The inventive apparatus generally includes two elements or sections—a filtration section and a chlorine dioxide detector section. In the apparatus of FIG. 1, a filtration container and a chlorine dioxide detection container provide these two elements. Preferably, both the filtration container and the detection container are provided in the form of glass tubes (12, 14), and are fluidly connected by way of a fluid connector (18). The filtration tube (12) includes an air inlet end (20) and an air outlet end (22). Similarly, the detection tube (14) includes an air inlet end (24) and an air outlet end (26). As illustrated, the connector (18) fluidly interconnects the filtration tube outlet end (22) with the detection tube inlet end (24). The connector (18) is preferably made out of rubber, but could be made of other flexible materials, such as a flexible plastic polymer.

The air outlet end (26) of the detection tube (14), as illustrated in FIG. 1, is fluidly connected with an air pump (16), that is operable to draw vapor through the filtration tube (12) and the detection tube (14). Although an air pump is disclosed as the preferred embodiment, other means for moving vapor through the tubes could be used, such as a fan, or other positive pressure generating device. When using a positive pressure generating device, such as a fan, to pass the vapor through the tubes, the fan is fluidly connected with the inlet end (20) of the filtration tube (12).

Referring now to FIG. 2, the filtration tube and detection tube are revealed in more detail. As illustrated in FIG. 2, the filtration tube (12) and the detector tube (14) have hermetically sealed ends (32, 34, 36, 38). Additionally, the filtration tube (12) contains a filter material (42) and the detection tube (14) contains a detection material (44). Specifically, the filter tube (12) houses or holds a filter material (42) adapted to remove or separate molecular chlorine from a vapor containing both molecular chlorine and chlorine dioxide. This filter material (42) can be deposited on an inert support, and is preferably sulfamic acid, which—as is readily known in the art—preferentially reacts with molecular chlorine. The inert support on which the filter material (42) is preferably deposited is pearlite. Other alternative inert support materials include vermiculite, silica gel, silica sand, and a mixture of alumina (55-60%) and silica gel (35-40%).

As suggested above, the detection tube (14) holds or houses a quantity of detection material (44). In operation, the detection tube (14) functions to detect the concentration of the chlorine dioxide in the vapor in the detection tube (14). In the preferred embodiment, the detection material (44) reacts colorimetrically with chlorine dioxide to produce an observable and measurable color change. Detection materials that are known to react colorimetrically with chlorine dioxide include o-tolidine (which produces an orange color in the presence of chlorine dioxide) and 3,3,5,5, tetramethylbenzine (which produces a pink color in the presence of chlorine dioxide).

In alternative embodiments of the present invention, the detection material (44) may be an electrochemical sensor, a substance that produces a chemilluminescent reaction with chlorine dioxide, or a substance that colorimetrically reacts with chlorine dioxide (such as a para-substituted phenylene ring compound where the substituent moieties are selected from the group consisting of aminoalkyl rings and alkyl rings, such as 1,1, para-phenylene dipiperidine or colorimetric reaction with N,N, diethyl para phenylenediamine (DPD), followed by titration with ferrous ammonium sulfate). The detection material (44) may be deposited on an inert support, such as inert supports similar to those described for the filter material (42).

In a preferred method for detecting chlorine dioxide in a vapor containing both chlorine dioxide and molecular chlorine, the filter and detection tubes (12,14) are provided for use as hermetically sealed glass tubes, as discussed above. The filter and detection tubes (12,14) are prepared for use by first opening the sealed ends, and then interconnecting the outlet end (22) of the filter tube (12) with the inlet end (24) of the detection tube (14). In a preferred embodiment, a connector (18) is used to provide fluid connection between the respective tubes (12,14).

Alternatively, the tubes (12, 14) may be provided with ends that join together without the use of a connector (18). Further yet, the inventive apparatus may employ a single tube to house both the filter element and chlorine detector element, as in the alternative embodiment of FIG. 3. One advantage of using a two-tube apparatus configuration, however, is that it provides the user the ability to interchange the filter and detection components.

As shown in FIG. 1, an air pump (16) is connected to the outlet end (26) of the detection tube (14). The air pump (16) is preferably one of several commercially available hand-operated pumps. Once the tubes (14,16) are properly installed, the air pump (16) may be operated to introduce a vapor sample into the inlet end (20) of the filter tube (12). The vapor is initially drawn through the filtration tube (12) and the sulfamic acid (42) contained therein. The sulfamic acid (42) removes or filters out the molecular chlorine, allowing the chlorine dioxide to pass through the tube (12) and into the detection tube (14). The chlorine dioxide then colorimetrically reacts with the detection material (44). The concentration of chlorine dioxide in the vapor sample can then be detected by visually inspecting the calorimetric change in the detection material (44). More particularly, the chlorine dioxide concentration may be measured by using a concentration scale (46) of the detection tube (14) to measure the intensity of the calorimetric change. The scale (46) is disposed on the outside of the transparent glass tube (14) and is calibrated to correspond the length of the stain, i.e., its intensity, with chlorine dioxide concentration. Thus, the chlorine dioxide concentration detected may be measured by using the scale (46) to measure the length of the colorized stain.

In the alternative embodiment of FIG. 3, the inventive apparatus employs a single glass tube (60). The tube (60) holds both filter material (52) and detection material (54). The filter material (52) is located adjacent the tube inlet (50), and the detection material (54) is located adjacent the tube outlet (51).

The inventive apparatus and method provide several important attributes, among which are convenience, flexibility, and practicality. In contrast to prior art techniques for quantifying chlorine dioxide, the present invention is suitable for applications wherein chlorine and chlorine dioxide coexist in vapor. As one result, the measurements provided by the inventive apparatus are generally more accurate. To illustrate, certain prior art techniques require the use of imperfect conversion factors to determine chlorine dioxide concentrations following an initial determination of the molecular chlorine concentration. Further, these techniques do not measure chlorine dioxide independently from molecular chlorine and thus, a level of error can be introduced into the analysis by the presence of molecular chlorine.

Another important aspect of the inventive apparatus is that it provides a convenient field-carryable, field-assembled chlorine detection device. In contrast, many of the prior art techniques required bulky equipment or could only be employed using non-portable equipment found in the lab.

Various embodiments of the present invention have been described herein. It should be understood by those of ordinary skill in the art, however, that the above-described embodiments of the present invention, such as the apparatus with two tubes connected with or without a connector and the apparatus with only one tube containing the filter material and the detection material, are set forth merely by way of example and should not be interpreted as limiting the scope of the present invention, which is defined by the appended claims. Many other alternative embodiments, variations and modifications of the foregoing embodiments that embrace various aspects of the present invention will also be understood upon a reading of the detailed description in light of the prior art. For instance, it will be understood that features of one embodiment may be combined with features of other embodiments while many other features may be omitted (or replaced) as being nonessential to the practice of the present invention.

What is claimed is:

1. An apparatus for detecting chlorine dioxide in a vapor having both chlorine dioxide and molecular chlorine, said apparatus comprising:
a first container including a first material adapted to remove molecular chlorine from a vapor having both chlorine dioxide and molecular chlorine; and
a second container including a second material adapted to detect chlorine dioxide; and
wherein said first and second containers are fluidly interconnectable, such that a vapor can be passed through said first container to remove molecular chlorine therefrom and then into said second to detect chlorine dioxide.

2. The apparatus of claim 1, wherein said first material is chemically-reactive with the molecular chlorine.

3. The apparatus of claim 1, wherein said first material includes sulfamic acid.

4. The apparatus of claim 1, wherein said second material is a material colorimetrically reactive with chlorine dioxide to produce a color change in said second material, the intensity of color change being proportional to the concentration of chlorine dioxide detected.

5. The apparatus of claim 4, wherein said second material comprises o-tolidine.

6. The apparatus of claim 4, wherein said second material comprises 3,3,5,5, tetramethylbenzine.

7. The apparatus of claim 1, further comprising a pump disposed in fluid communication with said first and second containers, said pump being operable to draw the vapor through said first and second containers.

8. The apparatus of claim 1, wherein said first and second containers have inlets and outlets, and wherein said outlet of said first container is adapted for direct connection with said inlet of said second container.

9. The apparatus of claim 1, wherein said second material is a material colorimetrically reactive with chlorine dioxide to produce a color change in said second material, the intensity of color change being proportional to the concentration of chlorine dioxide detected, and wherein said second container is a transparent container having a readable measuring scale on the outside of said second container, said measuring scale being calibrated to correspond chlorine dioxide concentration with the intensity of color change in the second material, such that a user of the apparatus can read the concentration of chlorine dioxide detected.

10. A method of detecting chlorine dioxide in a vapor having both chlorine dioxide and molecular chlorine, said method comprising the steps of:
providing a first container holding a first material reactive with the vapor to remove molecular chlorine from a vapor having both chlorine dioxide and molecular chlorine;
providing a second container holding a second material reactive with chlorine dioxide;
passing a vapor past said first material, such that the first material reacts with the vapor, thereby removing molecular chlorine from the vapor; and
after the vapor is passed past said first material, passing the vapor past said second material, such that the second material reacts with the vapor, thereby detecting the concentration of chlorine dioxide in the vapor.

11. The method of claim 10, wherein said step of providing a first container holding a first material includes selecting a first material that is chemically reactive with the vapor having both chlorine dioxide and molecular chlorine to remove molecular chlorine from the vapor.

12. The method of claim 11, wherein said step of providing the first container with material for removing molecular chlorine includes providing sulfamic acid as the first material.

13. The method of claim 11, wherein said step of providing first and second containers includes providing a sealed first container having a sealed inlet end and a sealed outlet end, and a sealed second container having a sealed inlet end and a sealed outlet end, said method further comprising, prior to the step of passing the vapor past the first material, the steps of:
opening the sealed outlet end of the first container and the sealed inlet end of the second container;
interconnecting the outlet end of the first container with the inlet end of the second container, thereby providing fluid connection between said first container and said second container;
positioning a pump in fluid connection with said second container outlet end; and
opening the inlet end of the first container and the outlet end of the second container, thereby providing fluid connection between said second container, said first container, and said pump, wherein said step of passing the vapor past the first material includes operating said pump.

14. The method of claim 13, wherein said step of providing a second container holding a second material reactive with chlorine dioxide includes selecting a second material that is colorimetrically reactive with chlorine dioxide to produce a color change in the second material, the observable intensity of the color change being proportional to the concentration of chlorine dioxide detected.

15. An apparatus for detecting chlorine dioxide in a vapor having both chlorine dioxide and molecular chlorine, said apparatus comprising:
a tubular body having an inlet, a filter section, a chlorine detection section, and an outlet;
a first material positioned in said filter section, said first material being chemically reactive with vapor having both chlorine dioxide and molecular chlorine to remove molecular chlorine from the vapor; and
a second material positioned in said chlorine detection section, said second material being colorimetrically reactive with chlorine dioxide to produce a color change having an intensity proportional to the concentration of chlorine dioxide to which the second material is exposed;
wherein, said first and said second materials are positioned in said tubular body such that a vapor entering said inlet passes by said first material, such that molecular chlorine is removed from the vapor, and the vapor then passes by said second material, such that the concentration of chlorine dioxide is detected upon the observable change in color of the second material.

16. The apparatus of claim 15, wherein said first material is sulfamic acid.

17. The apparatus of claim 16, wherein said tubular body is a single unit, sealed prior to user operation and containing both the filter section and the chlorine detection.

18. An apparatus for detecting chlorine dioxide in a vapor having both chlorine dioxide and molecular chlorine, said apparatus comprising:
a first container having an inlet and an outlet, said first container holding a first material adapted to remove molecular chlorine from a vapor having both chlorine dioxide and molecular chlorine; and
a second container having an inlet and an outlet, and holding a second material adapted to detect chlorine dioxide; and
wherein said first and second containers are fluidly interconnectable such that said vapor can be passed by said first material to remove molecular chlorine therefrom and then passed by said second material to detect the concentration of chlorine dioxide in the vapor.

19. The apparatus of claim 18, wherein said first material is sulfamic acid.

20. The apparatus of claim 18, wherein said second material is a material colorimetrically reactive with chlorine dioxide to cause a measurable color change in said second material.

21. The apparatus of claim 20, wherein said second container is a transparent container having a readable scale thereon, said scale being calibrated to correspond the measurable intensity of the observable color change with the concentration of chlorine dioxide detected.

22. The apparatus of claim 21, wherein said second material is selected from the group of colorimetrically reactive materials consisting of: o-tolidine and 3,3,5,5 tetramethylbenzene.

23. The apparatus of claim 18, further comprising a fluid connector, wherein said first and second containers are sealed containers having inlets and outlets which can be opened prior to user operation of the apparatus, said first and second containers being fluidly connectable via said connector to provide a field-carryable apparatus.

24. The apparatus of claim 23, further comprising a pump operable to draw fluid flow through said first and second containers.

25. A method of detecting a concentration of chlorine dioxide in a vapor having both chlorine dioxide and molecular chlorine, said method comprising the steps of:
providing a chlorine filter element and a chlorine dioxide detector element;
fluidly interconnecting the chlorine filter element and the chlorine dioxide detector element;
passing the vapor past the chlorine filter element, thereby separating molecular chlorine and chlorine dioxides in the vapor; and
directing the separated chlorine dioxides past the chlorine dioxide detector element, thereby causing the chlorine dioxide detector to detect the concentration of chlorine dioxide passed.

26. The method of claim 25, wherein the chlorine filter element includes a material reactive with chlorine, said step of passing the vapor past the filter element including causing the material to react with the vapor, thereby removing the molecular chlorine from the vapor.

27. The method of claim 26, wherein the material reactive with chlorine is sulfamic acid, said step of passing the vapor including causing the sulfamic acid to react with the vapor, thereby removing the molecular chlorine from the vapor.

28. The method of claim 25, wherein the chlorine dioxide detector element includes a material reactive with chlorine dioxide, said step of directing the separated chlorine dioxides including causing the material to react with the separated chlorine dioxides, thereby detecting a concentration of the chlorine dioxide.

29. The method of claim 28, wherein said step of providing a chlorine dioxide detector element includes:
providing a transparent container,
selecting, as the reactive material, a material that is colorimetrically reactive with the separated chlorine dioxides, and
housing the chlorine dioxide reactive material in the transparent container; and
wherein said step of directing the separated chlorine dioxides causes a measurable color change in the reactive material.

30. The method of claim 29, wherein said step of providing a transparent container includes providing a readable scale on the container and calibrating the scale to correspond the measurable intensity of color change of the colorimetrically reactive material with the concentration of chlorine dioxide detected, such that said step of causing the material to react with the separated chlorine dioxides produces a color change with an intensity corresponding to a location on the scale, thereby providing a measure of the concentration of chlorine dioxide in the vapor.

31. The method of claim 30, wherein the first material is sulfamic acid, said step of passing the vapor including causing the sulfamic acid to react with the vapor, thereby removing the molecular chlorine from the vapor.

32. The method of claim 25, wherein said step of fluidly interconnecting the filter element and the chlorine dioxide detector element provides a field-ready carryable unit including both elements.

33. The method of claim 29, wherein the transparent container is a sealed, self-contained container, and wherein said step of providing a filter element and a chlorine detector element includes providing a self-contained, sealed filter container to house the chlorine reactive material, and wherein said step of fluidly interconnecting the filter element and the chlorine detector element includes fluidly interconnecting the filter container and the transparent chlorine detector container.

34. The method of claim 33, wherein said step of fluidly interconnecting includes,
unsealing an inlet of the filter container to allow for entry of the vapor from the local environment,
unsealing an outlet of the filter container and an inlet of the transparent chlorine detector container to allow fluid passage therebetween, and
unsealing an outlet of the transparent chlorine detector container to allow discharge of fluid from the transparent chlorine detector container.

35. The method of claim 34, further comprising the step of providing a pump as part of the field-ready carryable unit, wherein said step of passing the vapor past the filter element includes operating the pump to cause fluid flow through the filter container and the transparent chlorine detector container.
